(19) United States
(12) Patent Application Publication
(10) Pub. No.: US 2020/0162909 A1
(43) Pub. Date: May 21, 2020

(54) IMPROVEMENTS IN AND RELATING TO NETWORK COMMUNICATIONS

(71) Applicant: Global Reach Technology, Inc., San Jose, CA (US)

(72) Inventor: Christopher Spencer, London (GB)

(21) Appl. No.: 16/614,931

(22) PCT Filed: May 23, 2018
(86) PCT No.: PCT/GB2018/051410

§ 371 Date: Nov. 19, 2019

Related U.S. Application Data
(60) Provisional application No. 62/510,022, filed on May 23, 2017.

(51) Int. Cl. H04W 12/06; H04W 60/00; H04W 60/06; H04W 12/00; H04L 29/06; H04W 12/08

(52) U.S. Cl. CPC H04W 12/06; H04W 60/00; H04W 60/06; H04W 84/12; H04L 63/083; H04W 12/08; H04W 12/0013

(57) ABSTRACT

A method for authenticating a client device in a communications network, including obtaining network access credentials (32) for the client device from an authentication server apparatus for a communications network, and displaying on the client device a user interface arranged for receiving a user input command to connect the client device to the communications network. The method includes receiving the user input command (33) at the client device and in response thereto disassociating the client device from the network. The method includes transmitting the network access credentials (38, 39) for the client device to the authentication server apparatus which is responsive thereto to transmit to the client device an access accept message (39, 40).

### FIELD

The invention relates to communications networks, such as wireless networks or non-otherwise.

### BACKGROUND

A communications network typically permits users access to it via a network access point, or gateway. In many networks, such as public networks (e.g. the Internet) a user may be required to provide access credentials to the network access point before being permitted to access certain network services/websites etc. Only after these credentials have been verified by an authentication server/software, connected to the access point (or provided within it), is network access granted to the user. A ‘captive portal’ technique is a common mechanism for implementing a process of authentication for network access control.

Publicly accessible wireless “hotspots” allow members of the public access to network facilities. Hotspots (Wi-Fi) are physical locations where people may obtain Internet access, for example, typically using Wi-Fi technology, by a wireless local area network (WLAN), and are using a rotor to gain access to an Internet service provider. Businesses, such as airport shops or hotels, may typically provide hotspots within the premises for the benefit of their customers, by a local wireless access points (AP) configured to control the degree of Internet access according to the “policy” of the business. The policy may impose restrictions on which parts of the Internet may be accessed, and which parts may not thereby allowing access to only those parts of the Internet consistent with the “policy”, the allowed network parts, and preventing access to other parts.

FIG. 3 schematically illustrates the procedure via which this control is often achieved. In particular, the wireless local area network apparatus must be able to “provision” the client apparatus (6) of a user (user equipment, UE) with the necessary network access credentials and associated network access “policy”. For this purpose, public hotspots often need to allow users access to a registration portal (8) provided by an online sign-up server (OSU). Unfortunately, such access is usually via an insecure open network SSID (7). This means that once a user has taken steps to initiate connection (e.g. clicked a “connect” button on a user interface) to a WLAN, the client apparatus (6) will usually be required to begin transmitting personal registration data (e.g. name, phone number, address, credit card details etc.) to the registration portal (8) via unencrypted wireless channels (1). Once the user equipment (6) has been provisioned (3) with the necessary network access credentials and “policy”, registration procedures are completed, and a client apparatus must then disconnect (4) from the insecure open network SSID (7, 8) of the registration portal, and subsequently connect (5) to a separate, secure SSID (9) via which the desired network services (9) are available.

However, this connection step (5) relies on the user equipment (6) finds and connects to the correct secure SSID (9). Unfortunately, a user equipment (6) typically merely remembers and re-connects to the previous open network SSID (7, 8), or is at least slow at finding the secure SSID. This gives a poor service and user experience.

The invention provides an improved system for accessing a communications network.

### SUMMARY

At its most general the invention resides in the idea of providing a user equipment with the facility to present to the user an interface (e.g. GUI) via which the user can deliberately and purposely enter a user input/command which is effective to disassociate the user equipment from the authorisation in response to network access having been authorised e.g. by an AAA server. This facility may be provided to the user equipment by an Online Sign-Up Server (OSU) through which network access was requested. It is to be understood that the user input or command may be a user command which is manually input by a user, such as by clicking a button or item on a user interface to initiate transmission of the user command. Alternatively, the user input or command may be automatically input for the user by the client device by means, for example, of a count-down timer displayed on the user interface whereby the user command is deemed implicitly input at completion of the count-down, in the absence of a user command to the contrary.

In response to the user input, a ‘Change of Authorization’ (COA) message may be generated. The COA may be issued to a WLAN via which the network is to be accessed. This may have the effect of forcing the user equipment to become disassociated. The user equipment may be arranged subsequently to attempt to reconnect to the service set (e.g. defined by an SSID) from which it may have been disconnected as a result of the disassociation (i.e. caused by the COA message). The user equipment may be arranged to use the credentials previously issued by the AAA server immediately prior to disassociation, when attempting this reconnection (i.e. via the AAA server). The AAA server may be arranged to respond to the reconnection attempt of the user equipment by issuing to the user equipment an ‘Access Accept’ message—i.e. because the previously issued credentials remain valid. The AAA server's response may also include a VLAN attribute. The AAA server's response may also include other required RADIUS attributes. As a result of this, the user equipment acquires the appropriate network access as granted and enforced by the policy associated with those user credentials. User traffic may be tagged to an authorised VLAN.

Disassociation may be implemented by, for example, transmitting a ‘disassociation frame’. This may involve sending a disassociation frame to terminate the association of the user equipment from the network connection. For example, a disassociation frame may alert an access point or other network node, which may then remove the user equipment from an association table.

In a first aspect, the invention may provide a method for authenticating a client device in a communications network, including, obtaining network access credentials for the client device from an authentication server apparatus for a communications network, displaying on the client device a user interface arranged for receiving a user input command to connect the client device to the communications network, receiving the user input command at the client device and in response thereto disassociating the client device from the network, transmitting the network access credentials for the client device to the authentication server apparatus which is responsive thereto to transmit an to the client device an access accept message.

Desirably, the obtaining network access credentials includes, providing to the client device temporary network access credentials associated with the communications network, and transmitting by the client device the temporary network access credentials to the authentication server apparatus. In response to receipt of the temporary network access credentials by the authentication server apparatus, the method may include connecting the client device to a segregated part of the communications network for encrypted communications therewith transmitting user registration data from the client device to the segregated part of the communications network by said encrypted communications, and subsequently receiving the network access credentials from the authentication server apparatus by said encrypted communications.

Desirably, in response to receipt of the temporary network access credentials by the authentication server apparatus, the method may include receiving at the client device replacement network access credentials transmitted from the authentication server apparatus permitting said connecting the client device to the segregated part of the communications network.

Desirably, in response to receipt of the temporary network access credentials by the authentication server apparatus the method may include, by encrypted transmission from the client device, transmitting the replacement network access credentials to the authentication server apparatus, therewith to connect said client device to the segregated part of the communications network.

Desirably, the transmitting of the network access credentials may include transmitting from the client apparatus a request to reconnect to the communications network from which the client apparatus had been disassociated by said disassociating the client device from the network.

Desirably, the disassociating the client device from the network includes disconnecting the client device from the segregated part of the communications network.

Desirably, the request to reconnect is made to the apparatus having the same service set identification (SSID) as the apparatus from which the client apparatus had been dissociated by said disassociating the client device from the network.

Desirably, the receiving of the replacement network access credentials includes receiving a username and/or a password and/or network access permissions/restrictions for accessing the communications network.

In a second aspect, the invention may provide a network communications apparatus for authenticating a client device in a communications network, including, apparatus for obtaining network access credentials for the client device from an authentication server apparatus for a communications network, a display on the client device for displaying a user interface arranged for receiving a user input command to connect the client device to the communications network, apparatus for receiving the user input command at the client device and in response thereto disassociating the client device from the network, apparatus for transmitting the network access credentials for the client device to the authentication server apparatus which is responsive thereto to transmit an to the client device an access accept message.

Desirably, the apparatus for obtaining network access credentials includes apparatus for providing to the client device temporary network access credentials associated with the communications network. Desirably, the client device is arranged to transmit the temporary network access credentials to the authentication server apparatus. Preferably, in response to receipt of the temporary network access credentials the authentication server apparatus is arranged to connect the client device to a segregated part of the communications network for encrypted communications therewith. Desirably, the client device is arranged to transmit user registration data to the segregated part of the communications network by the encrypted communications. Desirably, the authentication server apparatus is arranged to subsequently transmit said network access credentials to the client apparatus by said encrypted communications.

Preferably, in response to receipt of the temporary network access credentials by the authentication server apparatus, the authentication server apparatus is arranged to transmit to the client device replacement network access credentials permitting said connecting the client device to the segregated part of the communications network.

Preferably, in response to receipt of the temporary network access credentials by the authentication server apparatus, the client device is arranged by encrypted transmission to transmit the replacement network access credentials to the authentication server apparatus, therewith to connect said client device to the segregated part of the communications network.

Desirably, the transmitting of the network access credentials includes transmitting from the client apparatus a request to reconnect to the communications network from which the client apparatus had been disassociated by said disassociating the client device from the network.

Desirably, the disassociating the client device from the network includes disconnecting the client device from the segregated part of the communications network. Preferably, request to reconnect is made to the apparatus having the same service set identification (SSID) as the apparatus from which the client apparatus had been dissociated by said disassociating the client device from the network. Desirably, the client device is arranged to receive the replacement network access credentials which include a username and/or a password and/or network access permissions/restrictions for accessing the communications network. A service set identifier (SSID) refers to an identifier data item, used as an identifier for a WLAN (wireless LAN). In computer networking, a service set (SS) is a set consisting of all the devices associated with a consumer or enterprise wireless local area network (WLAN)—e.g. IEEE 802.11. The service set can be local, independent, extended or mesh. A LAN is an abbreviation for local area network. A virtual LAN (VLAN) is any broadcast domain that is partitioned and isolated in a computer network at the data link layer. The term ‘virtual’ refers to a physical object recreated and altered by additional logic. VLANs employ tags within network packets and tag handling in networking systems. As a consequence a VLAN may allow networks to be kept separate despite being connected to the same network. It does so without requiring multiple sets of networking devices to be deployed. This recreates the appearance and functionality of network traffic that is physically on a single network but acts as if it is split between separate networks.

### BRIEF DESCRIPTION OF DRAWINGS

FIG. 1 schematically describes the components of an apparatus, and associated process steps, for allowing a user equipment (UE) to gain access to a network (e.g. the internet);

FIG. 2 schematically illustrates a sequence of communications between a user equipment (UE) of a client and a WLAN network according to an embodiment of the invention;

FIG. 3 schematically illustrates connections in the registration process in connecting to a Wi-Fi hotspot;

FIG. 4 schematically shows a display of the user equipment (UE) including a user interface displaying a button to be clicked to input to the client device a user command to connect the client device to the WLAN communications network.

### DESCRIPTION OF EMBODIMENTS

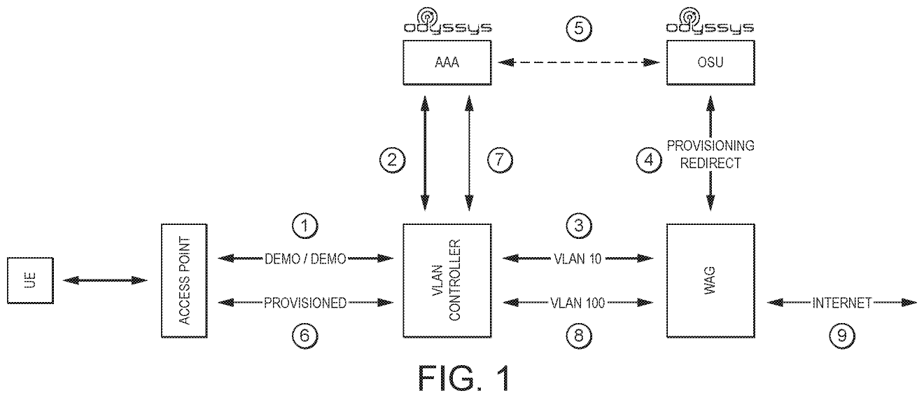

An embodiment of the invention, shall now be described with reference to FIG. 1. This is provided for illustration to allow a better understanding of the invention and is not intended to be limiting. FIG. 1 shows apparatus comprising the following components: A User Equipment ‘UE’, such as a client device (laptop etc.); An ‘ACCESS POINT’ (or AP) via which the ‘UE’ accesses the internet; A WLAN CONTROLLER′ in communication with the AP, and with an Authentication, Authorisation and Accounting server ‘AAA’, and a ‘WAG’ apparatus. The ‘AAA’ server is in communication with an ‘OSU’ server which is itself in communication with the ‘WAG’ apparatus.

These components of apparatus communicate as described below in steps (1) to (8) with reference to FIG. 1 and the communication arrows indicated therein with these process steps. Hot Spot 2.0 is a standard for public-access Wi-Fi that enables roaming among WiFi networks and between WiFi and cellular networks. It was developed by the Wi-Fi Alliance and the Wireless Broadband Association.

| | |
|---|---|
| \textcircled{1} | The user connects to the wireless network by entering a well know or |
| | previously shared username and password combination. In this case |
| | ‘demo’ and ‘demo’ |
| \textcircled{2} | The AAA server responds to those credentials putting the user into a |
| | walled garden, or segregated network VLAN |
| \textcircled{3} | The user traffic is kept away from fully authentciated users safely by |
| | VLAN separation. |
| \textcircled{4} | The WAG redirects all traffic to the OSU, The user is required to |
| | prove identity and download a Hotpsot 2.0 profile. |
| \textcircled{5} | At the and of the profits install the user is returned to the OSU |
| | which then displays a button informing the user to click to activate - |
| | What this does is call a webservice on the AAA to creata a COA to |
| | the WLAN controller, forcing the users device to become disassoci- |
| | ated. |

The user equipment ‘UE’ is now disassociated from the network (e.g. internet). The following steps then take place:

| | |
|---|---|
| \textcircled{6} | The users device immediately attempts a reconnnect to the previously |
| | connected SSID. |
| \textcircled{7} | The users deviceautomatcially submits the credentials issued by the |
| | OSU to the AAA, Which are now valid for access, The AAA now |
| | responds with an access accept and a VLAN attribute along with any |
| | other required RADIUS attributes |
| \textcircled{8} | The user traffic is now tagged to an authorised VLAN |
| \textcircled{8} | The user now has the appropriate internet access granted and enforced |
| | by the policy associated to the user credentials. |

Thus, a user-initiated COA step (5), shown in FIG. 1, is indicated by the dotted line between ‘AAA’ unit and the ‘OSU’ unit. The user initiated COA is different to a process of a user simply e.g. logging out of Wi-Fi. The difference includes the step of sending a COA to the controller to initiate the WLAN CONTROLLER′ thereby pushing the client device ‘UE’ off the Access Point ‘AP’. A key principle is that the user initiates this. That is to say, the user takes an active step to be pushed off the network, with that outcome intended.

The RADIUS protocol (Remote Authentication Dial In User Service) is an industry standard protocol for authentication, authorization, and accounting (AAA). RADIUS is often the backend of choice for 802.1X authentication. Terminal servers or Network Access Server (NAS) use the RADIUS protocol to communicate AAA requests to, and return results from, a database of customer information. The RADIUS protocol may be defined in Internet Engineering Task Force (IETF) “RFC” documents, such as RFC 2058 and any one or more of the subsequent RFC documents which have obsoleted RFC 2058 and/or have themselves been obsoleted by successive RFC documents defining the RADIUS protocol (or aspects of it), such as any one of, or a combination of, RFC 3579, RFC 2866 and RFC 3580 or may be used RFC 6614 for example.

A RADIUS server uses the RADIUS protocol to provide AAA services. A RADIUS server performs AAA services required when customers use a terminal server or Network Access Server (NAS). The RADIUS server performs the following tasks:
Authentication: Verifying a customers identity by checking the user name and password
Authorization: Verifying a customers privileges for accessing the requested services
Accounting: Tracking when customers log in and log out, and the duration of the sessions.
   The term “Accounting” refers to tracking customer usage.

A common authentication tool is to use a so-called “captive portal”. A captive portal uses a standard web browser to permit a user the opportunity to present login details/credentials to a network service, before access to that service is granted. The use of a web browser in this way means that many personal computer operating systems (laptops, PCs etc.) can support captive portals, and bespoke software is not required.

When a RADIUS server is used for authentication purposes, it may return one of two responses to the network access point: an ‘Access Reject’ response; or an ‘Access Accept’ response. An ‘Access Reject’ response occurs to deny access to the requested network resources if the user has failed to provide acceptable credentials. An ‘Access Accept’ response occurs when a user is granted access.

An ‘ACCESS POINT’ sends a RADIUS Access Request message to the RADIUS server (AAA), via the WLAN CONTROLLER′ requesting authorization to grant access via the RADIUS protocol. This request includes access credentials (e.g. username, password or security certificate) provided by the client device/user. The RADIUS server (AAA′) checks that the information is correct.

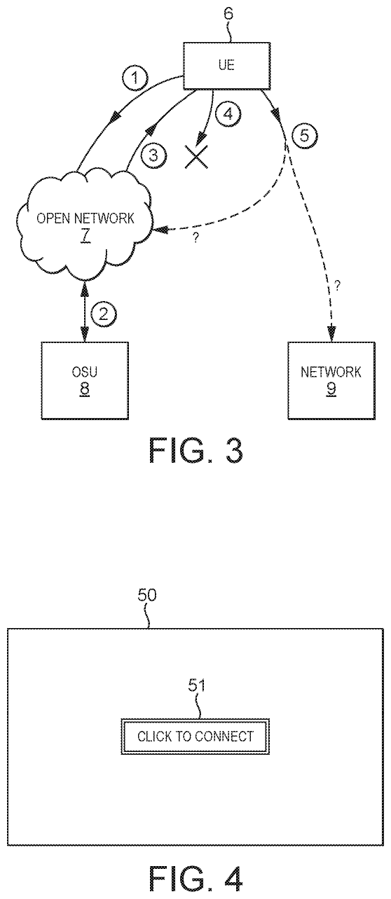

Presently, network operators wishing to offer a more secure approach to sign-up and registrations to a network can thereby create a secure encrypted Wireless (Wi-Fi) network, e.g. using a variety of EAP protocols (Extensible Authentication Protocol) or Hotspot 2.0 protocols. However, as discussed above with reference to FIG. 3, the problem with existing systems is that no user can connect to that secure SSID without knowing their own secure authentication details, such as a username and password or have a Hotspot 2.0 profile installed on their device already. In principle, the network owner in that case may openly advertise a temporary username/password that anyone could use to connect to the network securely, however a shared username and password does not allow them to differentiate the service from another network service (e.g. identify users and provide bespoke services) or allow user registration.

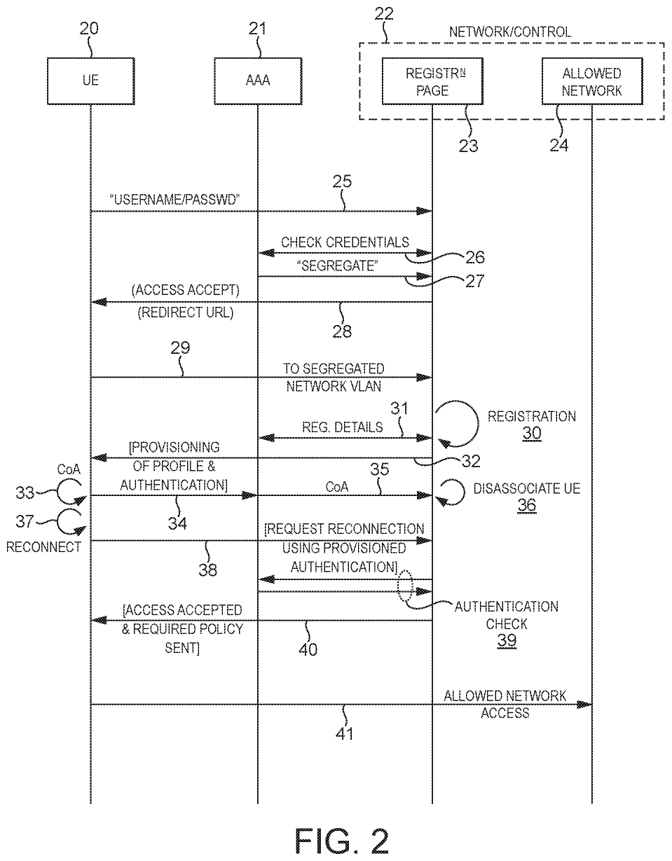

The present invention provides the required provisioning of users securely. Referring to FIG. 2, the user equipment (UE, 20) attempts to connect to a secure SSID of a network (22) comprising network access and control apparatus such as shown in FIG. 1. The user is prompted by the operating system of the UE to enter a username and password to gain access to the encrypted network. The user has previously been provided with a temporary username and password, and they enter (25) these at a registration page of the network. The temporary username and password maybe provided to the user by the network apparatus using shared means, for example on a website associated with the network service, or in an email to the user or to a third party (e.g. a friend) then may convey the information to the user.

For example, the user may have obtained the username/password combination from their mobile telephone service provider (MobileCo). The user is provided with a temporary username of ‘mobileco’ and a temporary password of ‘mobileco’. The user is thereby able to enter (25) the temporary username ‘mobileco’ and associated temporary password ‘mobileco’ to the registration page (23) of the network (22). This temporary username and password is sent (26), by the network control apparatus, back to the AAA Radius server (21) of the network for validation. The AAA Radius server responds (27) with an access accept because the temporary username and password are correct in this case, together with a notification (27) to the network control apparatus (23) to segregate the user equipment (20) within a predefined, secure restricted/segregated area of the network. The network control apparatus associated with the registration page (23) is responsive to the AAA server to issue (28) to the user equipment (20) not only an access accept message, but also a redirect URL and/or a VLAN ID and/or policy which is operable to direct the user equipment to a the secure, segregated area of the network.

The user is then connected (29) to the segregated part of the Wi-Fi network (22) securely and their data in air is encrypted. However, because they used the ‘well know username and password’, the user equipment is redirected (30) to the MobileCo's registration page instead of granted full internet access. At the registration page the user must complete their registration or activation (31), and may typically be required to enter their mobile phone number or email address. Once a user's identity has been proved, then a AAA profile is created and a secure mobile profile is generated for their device, presented and installed over the air securely (32). This is a secure process of provisioning a profile and authentication credentials to the user apparatus.

In a variant of the above steps, the initial connection attempt (25) could use an anonymous EAP instead of using a temporary username and password, and the AAA server (21) would, in that scenario, be arranged to identify that the EAP input was not a personalised username and password and would respond by putting the user equipment (20) into the required restricted policy and redirecting the user equipment to the registration page (23) to generate a profile as described above.

The provisioned/installed profile now contains the user's personalised username/password along with other items required to connect to the allowed part (24) of the secure network. For example, the provisioned profile could contain the correct Hotspot 2.0 setting and profile. The user equipment (20) has now obtained the correct username and password in the downloaded profile but still stuck on the restricted access network associated with the registration page (23) because they provisionally authenticated with the temporary/shared username and password. In order to resolve this problem, a display (FIG. 4) on the user equipment (20) is controlled to display to the user a connection activation button which they are prompted to click, as an active user input/command (33), to implement connection to the desired/allowed network area (24). FIG. 4 schematically shows an example of a user interface on a display (50) of the client device displaying such an activation button (51) to be clicked to input the user command to connect the client device to the WLAN communications network. The activation button displays a message “click to connect” indicating the action required by the user to complete connection to the allowed network. Once clicked, the client device has thereby received the user input command and in response thereto the process of disassociating the client device from the network ensues. Alternatively, a connection activation count-down timer may be displayed and the user equipment controlled to implement connection to the desired/allowed network area upon completion of the count-down, in the absence of a user input/command to the contrary. In that case, the activation button (51) of the user interface displayed on the display (50) of the client device (UE) would be replaced by a count-down timer displaying a counting-down time, in place of the “click to connect” message shown in FIG. 4.

The input of a user input/command by the connection activation button or via the counter-downtime, automatically triggers a backend CoA signal (34, 35) to the WLAN controller of the network control apparatus (22) creating a temporary dis-association between the user equipment (20) and the WLAN of the network control apparatus. The user equipment is thereby disconnected (36) from the network control apparatus.

Because the user equipment (20) has previously been provisioned (32) with the correct network profile containing the generated personalised username and password or authentication token, the user equipment is able and arranged to automatically reconnect (38) back to the same WLAN of the network control apparatus (22), this time using the personalised username and password contained in the profile, instead of the temporary username/password. Once validated (39) by the AAA (RADIUS) server (21), the network control apparatus is arranged to send back (40) an access accept message to the user equipment containing the correct policy allowing the user equipment to connect using their allowed internet or network access (41).

The benefits of this arrangement include that all of the registration, authentication and connection of the user equipment to the network is performed on a single secure WLAN. Additionally, the single WLAN network can support multiple operators as well as anonymous EAP, each operator would make their own subscriber base aware of their own shared username and password, for example another operator called MobileCo2 with username and password of mobileco2, may provide that temporary username/password combination to their customers to separately and independently implement network connection to an allowed network area associated with MobileCo2. The AAA server (21) would see this username and password and respond putting the UE into a restricted state as described above but redirecting them to MobileCo2's provisioning page.

The invention has multiple benefits, including that every aspect of the sign-up process is done with in air encryption, and is therefore secure. A single SSID, associated with the network control apparatus (22), is used by mobile operators, and this avoids mobile operators having to use a large number of SSIDs which would cause RF (radio frequency) pollution. The invention also prevents user equipment (e.g. mobile handsets) unintentionally reconnecting to the first/initial open SSID they registered with—a current and significant Hotspot 2.0 provisioning problem. Overall the invention enables a better user experience.

1. A method for authenticating a client device in a communications network, including:
obtaining network access credentials (32) for the client device from an authentication server apparatus for a communications network;
displaying on the client device a user interface arranged for receiving a user input command to connect the client device to the communications network;
receiving the user input command (33) at the client device and in response thereto disassociating the client device from the network;
transmitting the network access credentials (38, 39) for the client device to the authentication server apparatus which is responsive thereto to transmit to the client device an access accept message (39, 40).

2. A method according to claim 1 wherein the obtaining network access credentials includes:
providing to the client device temporary network access credentials associated with the communications network;
transmitting by the client device the temporary network access credentials to the authentication server apparatus;
in response to receipt of the temporary network access credentials by the authentication server apparatus, connecting the client device to a segregated part of the communications network for encrypted communications therewith;
transmitting user registration data from the client device to the segregated part of the communications network by said encrypted communications;
subsequently receiving said network access credentials from the authentication server apparatus by said encrypted communications.

3. A method according to claim 2 wherein, in response to receipt of the temporary network access credentials by the authentication server apparatus;
receiving at the client device replacement network access credentials transmitted from the authentication server apparatus permitting said connecting the client device to the segregated part of the communications network.

4. A method according to claim 3 wherein in response to receipt of the temporary network access credentials by the authentication server apparatus:
by encrypted transmission from the client device, transmitting the replacement network access credentials to the authentication server apparatus, therewith to connect said client device to the segregated part of the communications network.

5. A method according to claim 1 wherein the transmitting of the network access credentials includes transmitting from the client apparatus a request to reconnect to the communications network from which the client apparatus had been disassociated by said disassociating the client device from the network.

6. A method according to claim 2, wherein the disassociating the client device from the network includes disconnecting the client device from the segregated part of the communications network.

7. A method according to claim 5, in which said request to reconnect is made to the apparatus having the same service set identification (SSID) as the apparatus from which the client apparatus had been dissociated by said disassociating the client device from the network.

8. A method according to claim 3, in which said receiving of the replacement network access credentials includes receiving a username and/or a password and/or network access permissions/restrictions for accessing the communications network.

9. A network communications apparatus for authenticating a client device (20) in a communications network, including:
apparatus (23) for obtaining network access credentials for the client device from an authentication server apparatus (21) for a communications network;
a display on the client device for displaying a user interface arranged for receiving a user input command to connect the client device to the communications network,
apparatus (24) for receiving the user input command at the client device and in response thereto disassociating the client device from the network;
apparatus (23) for transmitting the network access credentials for the client device to the authentication server apparatus which is responsive thereto to transmit to the client device an access accept message.

10. A network communications apparatus according to claim 9 wherein the apparatus for obtaining network access credentials includes apparatus for providing to the client device temporary network access credentials associated with the communications network;
the client device is arranged to transmit the temporary network access credentials to the authentication server apparatus;
in response to receipt of the temporary network access credentials the authentication server apparatus is arranged to connect the client device to a segregated part of the communications network for encrypted communications therewith;
the client device is arranged to transmit user registration data to the segregated part of the communications network by said encrypted communications;
the authentication server apparatus is arranged to subsequently transmit said network access credentials to the client device by said encrypted communications.

11. A network communications apparatus according to claim 10 wherein, in response to receipt of the temporary network access credentials by the authentication server apparatus;
the authentication server apparatus is arranged to transmit to the client device replacement network access credentials permitting said connecting the client device to the segregated part of the communications network.

12. A network communications apparatus according to claim 11 wherein in response to receipt of the temporary network access credentials by the authentication server apparatus, the client device is arranged by encrypted transmission to transmit the replacement network access credentials to the authentication server apparatus, therewith to connect said client device to the segregated part of the communications network.

13. A network communications apparatus according to claim 9 wherein the transmitting of the network access credentials includes transmitting from the client device a request to reconnect to the communications network from which the client device had been disassociated by said disassociating the client device from the network.

14. A network communications apparatus according to claim 9, wherein the disassociating the client device from the network includes disconnecting the client device from the segregated part of the communications network.

15. A network communications apparatus according to claim 13, in which said request to reconnect is made to the apparatus having the same service set identification (SSID) as the apparatus from which the client device had been dissociated by said disassociating the client device from the network.

16. A network communications apparatus according to claim 11, in which the client device is arranged to receive the replacement network access credentials which include a username and/or a password and/or network access permissions/restrictions for accessing the communications network.
